(19) United States
(12) Patent Application Publication
(10) Pub. No.: US 2025/0373365 A1
(43) Pub. Date: Dec. 4, 2025

(54) Joint Contextual and Application Optimized HARQ

(71) Applicant: Apple Inc., Cupertino, CA (US)

(72) Inventors: Kenza HAMIDOUCHE, Cupertino, CA (US); Ahmed M SOLIMAN, Munich (DE); Ayman F NAGUIB, Cupertino, CA (US); Danila ZAEV, Munich (DE)

(21) Appl. No.: 19/222,476

(22) Filed: May 29, 2025

Related U.S. Application Data
(60) Provisional application No. 63/654,292, filed on May 31, 2024.

(51) Int. Cl. H04L 1/00; H04L 1/1607; H04L 1/1812; H04L 5/00

(52) U.S. Cl. CPC H04L 1/0058; H04L 1/1614; H04L 1/1812; H04L 5/0055

(57) ABSTRACT

An apparatus configured to process, based on signals received from a base station, a data unit comprising one or more representations, each of the representations comprising one or more data blocks, wherein each data block comprises a weight and wherein each of the data blocks is assigned to one of a plurality of code block groups (CBGs) based on the weight of the corresponding data block, determine a total weight of the data blocks that are successfully decoded and compare the total weight to a total weight threshold for the data unit.

### PRIORITY/INCORPORATION BY REFERENCE

This application claims priority to U.S. Provisional Application Ser. No. 63/654,292 filed on May 31, 2024, entitled “Joint Contextual and Application Optimized HARQ,” the entirety of which is incorporated by reference herein.

### Background

Wireless communication systems are rapidly growing in usage and constantly evolving. It is anticipated that future evolutions of the cellular standards, e.g., (3GPP standards) may include aspects of semantic communication. Some applications such as extended Reality (XR), co-presence, cloud gaming and computing offloading may have strict latency requirements that are challenging to satisfy under dynamic radio conditions and in congested resources. Semantic communications may implement a Hybrid Automatic Repeat Request (HARQ) process to increase reliability. However, how to implement such a process has not been defined.

### SUMMARY

Some example embodiments are related to an apparatus having processing circuitry coupled to memory, wherein the processing circuitry is configured to process, based on signals received from a base station, a data unit comprising one or more representations, each of the representations comprising one or more data blocks, wherein each data block comprises a weight and wherein each of the data blocks is assigned to one of a plurality of code block groups (CBGs) based on the weight of the corresponding data block, determine a total weight of the data blocks that are successfully decoded and compare the total weight to a total weight threshold for the data unit.

Other example embodiments are related to an apparatus having processing circuitry coupled to memory, wherein the processing circuitry is configured to generate, for transmission to a base station, a data unit comprising one or more representations, each of the representations comprising one or more data blocks, wherein each data block comprises a weight and wherein each of the data blocks is assigned to one of a plurality of code block groups (CBGs) based on the weight of the corresponding data block.

Still further example embodiments are related to an apparatus having processing circuitry coupled to memory, wherein the processing circuitry is configured to process, based on signals received from a user equipment (UE), a data unit comprising one or more representations, each of the representations comprising one or more data blocks, wherein each data block comprises a weight and wherein each of the data blocks is assigned to one of a plurality of code block groups (CBGs) based on the weight of the corresponding data block, determine a total weight of the data blocks that are successfully decoded and compare the total weight to a total weight threshold for the data unit.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example hierarchical protocol data unit (PDU) structure for semantic communications according to various example embodiments.

FIG. 5 shows an architecture for service optimized representations according to various example embodiments.

FIG. 6 shows an example of data unit encoding according to various example embodiments.

FIG. 7 shows an example method to determine a successful data unit reception according to various example embodiments.

FIG. 8 shows an example method to determine a successful data unit reception for soft blocks according to various example embodiments.

FIG. 9 shows a first example signaling in the case of a UE-centric joint contextual and application aware HARQ process for uplink transmissions according to various example embodiments.

FIG. 10 shows a second example signaling in the case of a UE-centric joint contextual and application aware HARQ process for uplink transmissions according to various example embodiments.

FIG. 11 shows an example signaling in the case of a joint contextual and application aware HARQ process for uplink transmissions according to various example embodiments.

FIG. 12 shows a call flow for application aware scheduling according to various example embodiments.

FIG. 13 shows a first example of an application aware grant calculation according to various example embodiments.

FIG. 14 shows a second example of an application aware grant calculation according to various example embodiments.

FIG. 15 shows a first example of application aware scheduling in the downlink according to various example embodiments.

FIG. 16 shows a second example of application aware scheduling in the downlink according to various example embodiments.

### DETAILED DESCRIPTION

The example embodiments may be further understood with reference to the following description and the related appended drawings, wherein like elements are provided with the same reference numerals. The example embodiments relate to various aspects of semantic communication. Specifically, the example embodiments relate to an improved HARQ process for sematic communications and for application aware scheduling for semantic communications.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a sixth generation (6G) network. However, reference to a 6G network is merely provided for illustrative purposes. The example embodiments may be utilized with any appropriate type of network and that supports semantic communications as described herein, including future evolutions of the cellular standards beyond 6G.

The example embodiments are related to semantic communications. Semantic communications differ from traditional or classic communications. Specifically, traditional communication modes use error-free deterministic communications, e.g., the data that is to be transmitted by a transmitter and received by a receiver is the actual data that is to be exchanged, e.g., data that represents pixel values of an image. In contrast, semantic communications are not limited to transmission of the actual data. Rather, semantic communications transmit semantic representations of the data, e.g., semantic data or metadata about the data that is to be transmitted. The receiver may use this semantic data or metadata to reconstruct the actual data that the transmitter intends without the transmitter sending the actual data.

One advantage of semantic communications is that the semantic representations of data, e.g., semantic data or metadata about the data to be transmitted, may be smaller than the actual data to be transmitted. To provide an example, the semantic representation of an image may be significantly smaller than the actual data of the image. This reduction in the amount of data required to exchange information between a transmitter and receiver may allow for higher throughputs to accommodate heavy traffic scenarios.

Semantic communications is not data compression. That is, traditional communication modes may use various compression algorithms to compress the size of the actual data, e.g., there are multiple forms of MPEG compression that reduce the size of video files for traditional communications. These forms of compression typically remove some of the actual data from the data being transmitted and the receiver may decode the compressed data using interpolation or other methods. Semantic communications are different from compression (or encoding) because the reduced amount of data used for semantic communications is not a subset of the actual data as in traditional communication compression.

To provide a very simple example of transmitting an image that includes a tree. Traditional communication modes need to represent each pixel of the image that includes the tree and transmit those representations of each pixel to the receiver. The receiver may decode the representations of each pixel and display the image. In contrast, in semantic communications, the semantic representation may be as simple as indicating a ‘tree.’ The receiver may then place a tree in the image. The semantic representation may be more complicated, e.g., ‘a tree with green leaves’, ‘a tree with fall color leaves’, ‘an oak tree’, etc. From this simple example, it can be seen that the amount of data used to convey the same information is significantly less using semantic communications.

The example embodiments describe different aspects for semantic communications. In a first aspect, an improved HARQ process for semantic communications is described. In a second aspect, application aware scheduling for semantic communications is described. Each of these aspects are described in greater detail below.

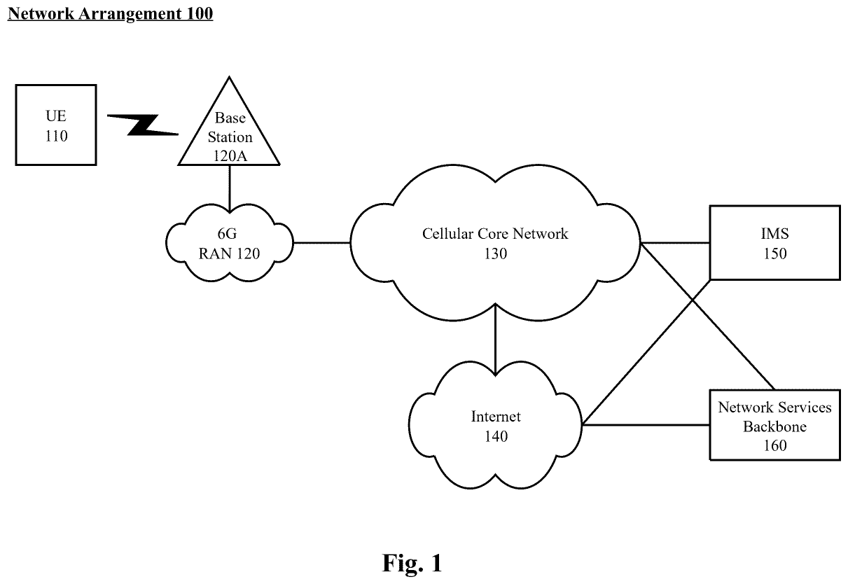

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., fifth generation (5G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have at least a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 6G RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC), the 6G core (6GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

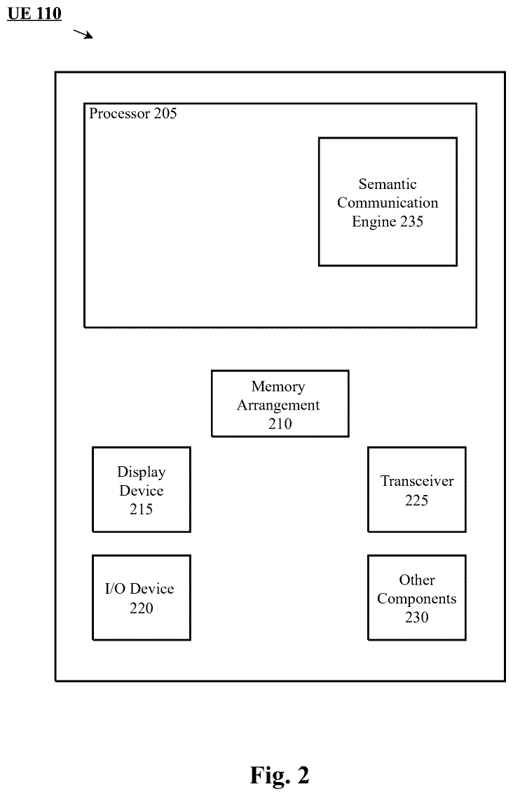

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a semantic communication engine 235. The semantic communication engine 235 may perform various operations related to semantic communications. To provide some general examples, the semantic communication engine 235 may perform operations such as, but not limited to, determining if data units of sematic communications have been decoded correctly, determining whether a retransmissions of data units should be performed, reporting application specific information for logical channels to a network and receiving uplink grants for data units. Each of these example operations will be described in greater detail below.

The above referenced engine 235 being an application (e.g., a program) executed by the processor 205 are merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 6G-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

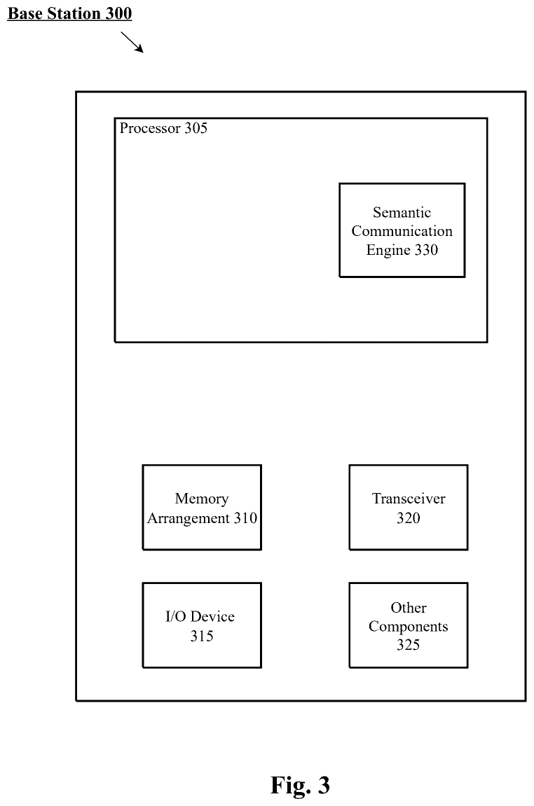

FIG. 3 shows an example base station 300 according to various example embodiments. The base station 300 may represent any base included within the network, e.g., base station 120A.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a semantic communication engine 330. The semantic communication engine 330 may perform various operations for the base station 300 related to related to semantic communications. To provide some general examples, the semantic communication engine 330 may perform operations such as, but not limited to, determining if data units of sematic communications have been decoded correctly, determining whether a retransmissions of data units should be performed, and determining uplink operations for a UE. Each of these example operations will be described in greater detail below.

The above noted engine 330 being an application (e. g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100.

The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode, decode and/or process signals (e.g., signaling from a UE) for implementing any one of the methods described herein.

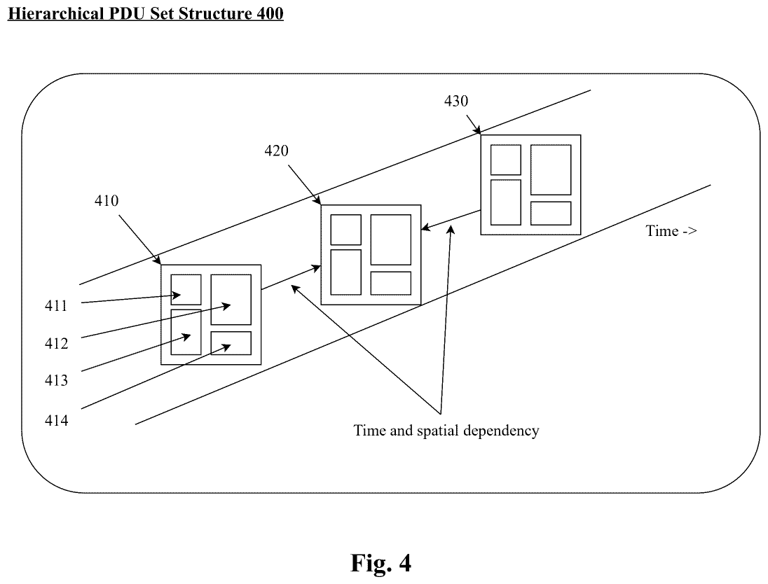

FIG. 4 shows an example hierarchical protocol data unit (PDU) structure 400 for semantic communications according to various example embodiments. The hierarchical PDU structure 400 may include representations 410-430 of any type of data flow, e.g., images, video frames, audio frames, etc. A representation may be a typical data burst generated by an application. As shown in FIG. 4, the different representations 410-430 may have time and spatial dependencies upon each other.

Within each representation 410-430, there may be blocks of data, e.g., image segments, video frame segments/slices, audio segments, etc.). For example, representation 410 may include blocks 411-414. A block describes a set of protocol data units (PDUs) that have value only if jointly received. In some example embodiments, some blocks may be soft blocks that allow a sub-packet level of priority handling. The blocks may also include dependencies and numerical weights.

Configuration of a data flow may be split into three parts to minimize redundancy. These three parts may include per flow representations (e.g., data category), per individual representation or per individual PDU.

The example embodiments use the above data structure to allow the communication layers to optimize functionalities and procedures. This may include defining metadata that should be passed to the lower layers to optimize the handling of the relevant data and better achieve application requirements.

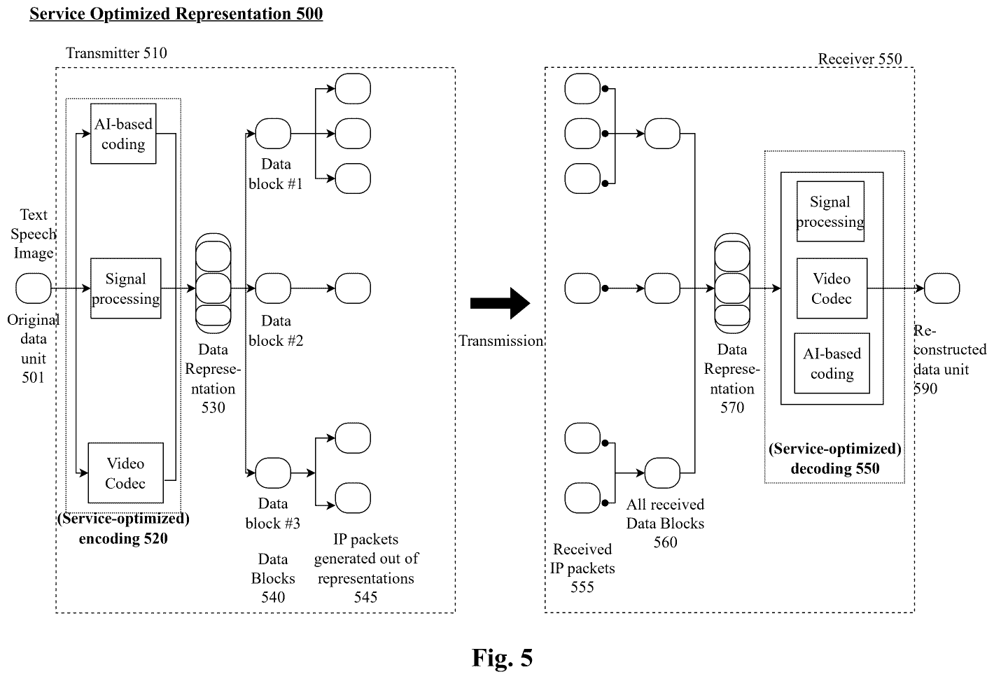

FIG. 5 shows an architecture 500 for service optimized representations according to various example embodiments. The architecture 500 comprises a transmitter 510 and a receiver 550. The transmitter 500 receives an original data unit 501 that may include, for example, text data, speech or audio data, image data, etc. The transmitter may perform source encoding that is the process of converting data of a given type to a form that is optimal for transfer, storage or further processing.

In this example, the source coding may be service-optimized encoding 520 that is a type of source encoding that equips the encoded data with an additional internal structure: a partition into blocks, the relative value of blocks for the application and interdependencies between the blocks. Examples may include multi-stream video/audio codecs (HEVC), codecs providing layered quantization, etc.

The next operation is to generate data representations 530 that is the generalization of the concept of a “PDU set”. It describes an output of application layer processing (e.g., an output of service-optimized encoding), which may be processed jointly by the application layer decoder at the receiver. The representation typically allows a description of an internal structure, including the data blocks, the value of the data blocks and interdependencies. Examples of representations may include encoded video frames with multiple resolution versions, encoded audio frames with multiple layers of residual vector quantization, etc.

The next operation is to generate data blocks 540 that are part of a data representation that may receive different treatments by the communication layers but packets and PDUs generated out of a single block may receive the same treatment. A data block may be considered to be correctly received if all its generated PDUs are correctly received. Data blocks of a representation may processed together by the application at the receiver 550 to reconstruct the original data unit.

IP packets may then be generated from the representations and transmitted to the receiver 550. The receiver 550 receives the IP packets 555 and, as described above, determines if all the data blocks 560 of the data representations are received. If all blocks 560 are received, the receiver 550 may reconstruct each representation 570 and then perform service-optimized decoding 580 to convert the encoded content back to its original form 590 (e.g., construct the original data unit 501), taking into account the data representation structure.

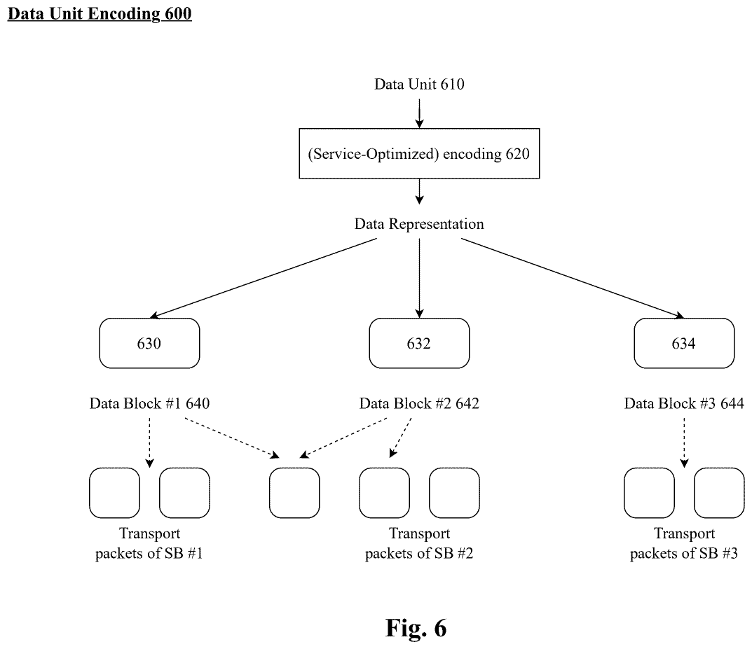

FIG. 6 shows an example of data unit encoding 600 according to various example embodiments. In an application-aware communication, a data unit 610 may be processed using a service-optimized encoding mechanism 620 to generate representations 630-634 typically comprising multiple data blocks 640-644.

This representation may have the following properties. A Data Unit 610->Data representations 630-634 (one-to-many correspondence). A single data unit may be mapped into one or many (in scenario with multi-modal data) service-optimized representations.

Data representation->Data Block (one-to-many mapping): multiple representations may be assigned to the same data unit and a single service-optimized representation may associated with a single data unit only.

Data block->packet (many-to-many mapping): data block may be mapped into multiple transport layer packets. A packet may include data of more than one data block.

Priority/relevance: each representation may be assigned a priority level or weight that defines the importance of the representation to reconstruct the original data unit in the decoding mechanism.

Interdependence: both blocks and representations may be interdependent. For example, two data blocks may be used together so that the source decoding mechanism at the receiver end is successful. The same may apply for two different representations.

Necessity and sufficiency: not all data blocks are necessary at the receiver for the reconstruction of the originally transmitted messages, e.g. representation.

Each receiver may have different requirements when it comes to the quality of reconstructed data units, depending on the application, transmission time, network capabilities, etc. For example, if the network is overloaded and the application is time-sensitive, a receiver/application may accept receiving a distorted version of the original message as long as the perceptual quality of the data is reasonable or as long as the message enables the receiver to perform its target task successfully.

As described above, the example embodiments may leverage the service-optimized representation structure to improve the HARQ process in semantic communications, e.g., application-aware HARQ. The HARQ process may be made more efficient by reducing the number of unnecessary retransmissions and guaranteeing the delivery of the most relevant data first. Latency may be reduced by limiting the number of retransmissions for the least relevant MAC SDUs. The number of retransmission per code block group may be defined based on the number and priority/weight of the successfully transmitted blocks.

For an application-aware HARQ, the receiver may adaptively accept some code blocks (CBs) to be lost and limit the number of retransmissions per CB depending on the relevance of the data contained in a CB. This can be defined using one of the following options. In a first option, a supported block error rate that corresponds to the maximum number of CBs that the application tolerates to be lost for the decoding process to be relatively successful. In a second option, a minimum required weight that corresponds to the total weight of the CBs that are correctly decoded at the receiver. This metric accounts for the relevance of the CBs/data blocks.

To support application-aware HARQ, the following conditions may satisfied. In a first condition, a position of the data blocks within a Transport Block (TB) or CBs may be known. In a second condition, information about data blocks (e.g., weight, dependency, priority) may be available at lower layers of the receiver. In a third condition, a lost sub-header within a TB may not block the decoding process of the following sub-headers and CBs.

In an application-aware TB structure, an application-specific header and/or application-specific sub-headers may be provided so that application related information about the Medium Access Control (MAC) Service Data Units (SDUs) in the TB may be passed to the receiver. The application-specific header may identify to which data blocks and data representations, the MAC SDUs belong to and that information may be accessed by the receiver. In addition, the information described below may be passed to the receiver through the application-specific TB headers and/or TB sub-headers.

The application related information included in the TB header and/or sub-headers may include one or more of a Representation ID, a Block ID (local ID in the Representation), a Data Category ID, a priority of the block, a dependency of the block, soft block information, an “End of Data Block” flag (e.g., the flag is a Boolean value which takes value TRUE if this MAC SDU is the last transmitted part of a Data Block), and a “Number of scheduled MAC SDUs of the Data Block” (e.g., how many MAC SDUs of this data block were already located in previously scheduled TBs and in the current TB before the considered MAC SDU).

The example embodiments introduce a joint contextual and application-aware HARQ process, that provides more flexibility to both the UE and base station in deciding whether some retransmissions are necessary. Such a decision may be made based on two types of information. The first type may be application related information that includes metadata that is included in the data category or data representation configuration. It mainly relates to the relevance of the data blocks and the interdependence relation between the blocks. Such information allows the communicating nodes to limit the number of retransmissions in the HARQ process based on a weight threshold that is provided by the application.

The second type of information is contextual information that includes the internal information of the UE and the base station and it can include the device's battery level, link quality, traffic load, available resources, etc.

To leverage this information in the decision making process about retransmissions, two directions may be considered, e.g., whether contextual information from the UE only or from both the UE and the base station are considered.

In a UE-centric HARQ, the UE/application may define a local weight threshold to indicate whether the decoded CBGs are sufficient for data unit reconstruction. The weight threshold w_{Th} may capture the condition from the application perspective to guarantee that the received blocks are sufficient to reconstruct the data unit in a reliable manner up to a level that is accepted by the receiver and/or application. The weight may be used by the base station or UE to decide whether retransmissions are required. All the decisions about what to retransmit either on the downlink or the uplink may be decided by the UE. Once the threshold is met or exceeded, any retransmission requests may be based on the contextual information of the UE that the UE may implicitly share with the base station in case of the downlink.

In a joint UE and base station-centric HARQ, based on its local parameters, the UE may define two weights to both evaluate the value of the received CBGs and help the base station evaluate whether it can deprioritize all or some of the retransmissions based on network conditions. A minimum weight threshold wₘᵢₙ that is similar to w_{Th} captures the conditions from an application perspective to guarantee that the received blocks are sufficient to reconstruct the data unit in a reliable manner up to a level that is accepted by the receiver and/or application. The UE provides the flexibility to the base station to omit some retransmissions in case the network is congested and resources are limited. If the total weight of the correctly received blocks is higher than wₘᵢₙ, the base station may not allocate resources in the scheduling grant (e.g., in the uplink) for some or all of the non-decoded CBGs. A maximum weight threshold wₘₐₓ that is higher than wₘᵢₙ may be defined by the UE. The UE may set this threshold when UE has limited power and determines to stop retransmission once the received blocks are sufficient to reconstruct the data unit up to a level that is accepted by the receiver and/or application. If the total weight of the correctly received blocks is higher than wₘₐₓ, the base station may not allocate any resources in the scheduling grant (e.g., in the uplink) for any of the non-decoded CBGs.

The HARQ process may perform the evaluation using a CRC check for every MAC SDU individually. Thus, all code blocks of a given data unit should have a successful CRC check to consider the data unit was successfully decoded/received. An advantage of the application-aware TB in HARQ may be that by creating a data representation of a data unit, the application metadata that is encapsulated in the TB header and sub-headers can be leveraged to evaluate whether a representation can be correctly reconstructed up to a level that is accepted by the application. To this end, a CRC check may be performed on all the CBGs to evaluate which CBGs/CBs can be successfully decoded. For the correctly decoded CBGs, the Data Representation ID and the Data Block ID may be retrieved to identify to which representation and block the decoded CBGs and MAC SDUs within it belong. This information is included in the TB header and/or sub-headers as described above. The CBGs may be decoded independently given that the structure of the TBs and CBGs is an application-aware structure.

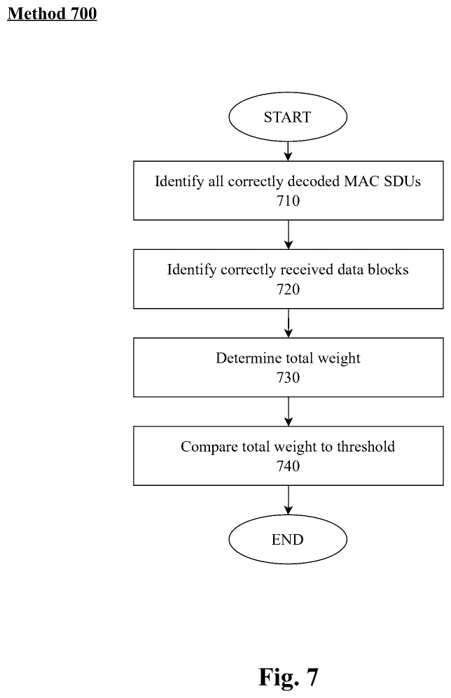

FIG. 7 shows an example method 700 to determine a successful data unit reception according to various example embodiments. In 710, the correctly decoded MAC SDUs are identified. For example, for each Data Block ID, check if all its corresponding MAC SDUs are correctly decoded. All data blocks that have at least one MAC SDU and/or MAC SDU segment not successfully decoded, should not be counted in the next operation.

In 720, the correctly received Data Blocks are identified. A data block may be considered as successfully received when all of its corresponding MAC SDUs and/or MAC SDU segments are received and correctly decoded. To derive that, the receiver may use the “Number of scheduled MAC SDUs of the Data Block” as well as the “End of Data Block” flag that are included in the TB header and/or TB sub-headers. For example, a data block may be considered to be successfully received if the following conditions are satisfied. The total number of MAC SDUs that are correctly decoded for a given data block corresponds to the “Number of scheduled MAC SDUs of the Data Block” in the MAC SDU of the same data block that has the “End of Data Block” Flag set to True. Given that the number of MAC SDUs per data block is variable, the defined condition guarantees that all MAC SDUs generated out of a single data block are all correctly decoded.

In 730, the total weight of the correctly decoded data blocks is determined. Following the operations in 710 and 720, the receiver may identify the data blocks that are correctly received for every data representation. Given that each data block is associated with a weight that is included in the TB header or TB sub-headers as well as the interdependency relationship between data blocks, the receiver may determine the total weight of the correctly received data blocks for a given data representation.

The interdependency captures the value of a data block in a representation depending on whether other data blocks from the same representation are received. Thus, the weight of a given data block may not be counted if the that data block depends on the successful reception of other data blocks. In the case of presence of redundancy, the receiver may identify the redundant data blocks and only count them once as part of the total weight.

In 740, the total weight determined in 730 may be compared to the acceptable weight threshold that is specified using data representation configuration. If the total weight satisfies the acceptable weight threshold, the receiver may determine that there is a successful data unit reception.

In some example embodiments, blocks may be soft blocks. For example, the described interface may be suitable for description of the limited number of relatively large data blocks, but in some types of representations, there may be a large number of small blocks. Typically, if the number of blocks is large, they follow a simple pattern, e.g., have equal size and their weights are progressed geometrically. To describe these situations, an extension to the service-optimized interface defining a novel type of data block is defined called a Soft Block. Soft blocks may be handled different from the usual blocks.

Soft blocks may have a regular structure with equal-sized sub-representations. For example, a soft block may have M×L sub-blocks, where M is the number of sub-blocks per layer and L is the number of layers. The weight of the entire soft block b may be represented by w_{b} and may be provided by the representation configuration. A parameter K is responsible for sub-blocks weight's progression w_{b}. Weights of the sub-blocks may be defined by the layer number, and the same for the sub-blocks within the layer. For example, the weights may be defined as:

$${w}_{b}^{l , m} := {c}_{b} \cdot {K}^{L - l} , l = 1 … L \\ {c}_{b} := \frac{{w}_{b} \cdot ( 1 - K )}{M \cdot ( 1 - {K}^{L} )} \\ {\sum }_{l , m} {w}_{b}^{l , m} = {w}_{b}$$

Thus, the internal structure of the soft block may be described fully by the three values (L, M, K), e.g., the number of layers, the number of sub-block per layer and the progressing coefficient of sub-blocks weights, respectively.

In the corresponding data category configuration or data representation configuration, some blocks of the representation may be marked as soft blocks. For each soft block, the structure (L, M, q) is provided, where L is the number of layers, M is the number of codewords per layer and K=2^{q} is the ratio of weights progression. For each soft representation, the condition for its reception acceptance (e.g., distortion threshold) may be provided and expressed as an absolute value within [0, w_{b}] or as a relative share in [0, 1] of the total block weight w_{b}. A soft block may be considered as received if the configured relaxed condition for reception is satisfied. All the other rules defined for legacy blocks may be similar for soft representations.

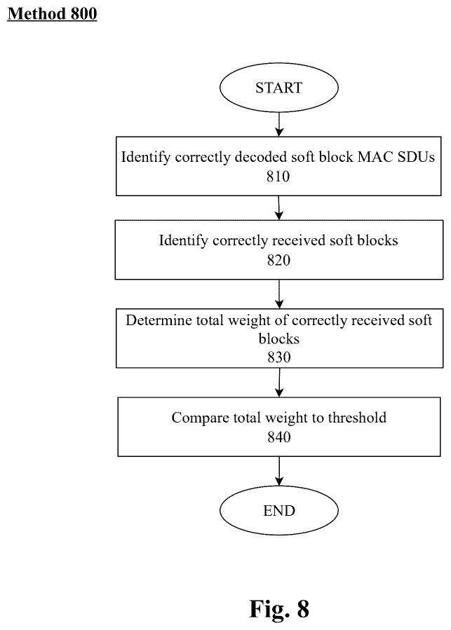

FIG. 8 shows an example method 800 to determine a successful data unit reception for soft blocks according to various example embodiments. In contrast to data blocks that need to be fully received to be considered, soft blocks tolerate information losses up to a given threshold. Moreover, soft blocks are composed of multiple sub-blocks that are assigned weights that capture the relevance of each of the sub-blocks. Thus, a soft block b may be considered as correctly received as long as the sum-weight of all the correctly decoded sub-blocks is higher or equal than a predefined threshold w_{Th}.

In 810, the correctly decoded MAC SDUs are identified. For each Soft Block ID, the MAC SDUs that are correctly decoded as well as the corresponding sub-blocks with the MAC SDUs. Are identified.

In 820, the correctly received Soft Blocks may be identified based on the set of correctly decoded sub-blocks for a given soft block, the corresponding weight and the predefined weight w_{Th} a soft block is considered as received if the configured relaxed condition for reception is satisfied. The receiver may still use the “Number of scheduled MAC SDUs of the Soft Block” as well as the “End of Data Block” Flag that are included in the TB header and/or TB sub-headers to identify the maximum number of MAC SDUs expected per soft block.

In 830, for every data representation identified in the 810 and 820, the receiver may identify the soft blocks that are correctly received based on the requirements of each of the soft data blocks. Similar to classical data blacks, each soft block is associated with a weight and the receiver may determine the total weight of the correctly received soft blocks for a given data representation.

In 840, the total weight determined in 830 may be compared to the acceptable weight threshold that is specified using data representation configuration. If the total weight satisfies the acceptable weight threshold, the receiver may determine that there is a successful data unit reception.

In the application-aware HARQ process, the ACK/NACK feedback on the CBGs may be defined as described below in both the downlink and the uplink. First, in the downlink, an explicit ACK may be used if the total weight is equal to or higher than the threshold, then all the received MAC SDUs can be transferred to the RLC layer and an ACK is sent to the transmitter. If there is a NACK and the base station is to retransmit, there may be two scenarios for the UE to send a NACK. In a first scenario, the total weight may be lower than the threshold and the receiver may send a NACK for all the non-received CBGs to request retransmission. In a second scenario, the UE may send a NACK to request retransmission for extra CBGs even though the threshold is met or exceeded. In this case, the Quality of Experience (QoE) may be important and the base station may satisfy these requests until it receives an explicit ACK from the UE.

Second, in the uplink, an implicit ACK may be used when the threshold is met or exceeded. For example, the base station may not request retransmission from the UE. On the UE side, the UE determines that data is successfully received and decoded by base station if the UE does not receive a retransmission request for a certain period of time. The base station may prefer not to request retransmission when, for example, the network is congested and resources are limited. For a NACK, the base station may request retransmission for all non-decoded CBGs but the UE may react in different options. In a first option, the UE may retransmit when the base station requests retransmission for extra CBGs even though the threshold is met or exceeded. In a second option, the UE may determine to retransmit only some of the requested CBGs and may also request the base station to stop retransmission requests as not needed based on the local parameters of the UE, e.g., battery level, traffic load, link quality, etc. If the threshold is not met and the base station sends retransmission requests for the CBGs that were not correctly decoded, the UE should retransmit all the requested CBGs.

In both the uplink and downlink, the receiver may store erroneous MAC SDUs in its buffer. Following the classical HARQ process, all versions may be used to improve decoding using soft-combining.

In some example embodiments, when MAC SDUs are ordered in the TB based on their weights, the application-aware HARQ process, the ACK/NACK feedback may be performed as follows. The MAC SDUs may be ordered from the MAC SDU with the highest weight to the one with lowest weight in the CBGs. In the downlink, the MAC SDUs with the highest weight are decoded first and if the total weight of successfully decoded MAC SDUs exceeds the predefined threshold, all the received MAC SDUs can be transferred to upper layer. The receiver may still request retransmission for some of the CBGs if necessary and these can be transferred later to RLC for joint processing with the previously received higher priority MAC SDUs. The decision on the CBGs to request retransmission for may be based on local parameters of the internal status of the device such as battery level or the required QoE.

In the uplink, similar to downlink, if the threshold is exceeded, the base station may still request retransmission for some of the CBGs if necessary and these may be transferred later to the RLC for joint processing with the previously received higher priority MAC SDUs. The decision may be made based on channel conditions, network traffic and available resources. Thus, the retransmission may be limited to a number of non-correctly decoded CBGs, e.g., the CBGs with highest weight up to a given level. In addition, the UE may also request the gNB to stop retransmission requests based on the UEs local parameters, e.g., battery level, traffic load, link quality, etc. If the threshold is not reached, then the base station may send retransmission requests for the CBGs that were not correctly decoded starting with the ones having the highest weight.

In addition to ordered MAC SDUs, two other TB structures options may be used by aligning the MAC SDU headers to the start of the CBs. The first option includes generating a TB for every range of weights from the highest range to the lowest. The second option includes having a single TB but aligning the MAC SDUs with the same weight into the same CBGs. In both cases, the application-aware HARQ process proposed in general or in the case of ordered MAC SDUs applies for these two options too and no changes are required.

In another option, a TB may be restricted to include MAC SDUs of a single Data Block only. In this case also, the HARQ process proposed for the ordered MAC SDUs and aligned MAC SDUs headers with CBs applies.

There may be various signaling that may be used to signal configuration information for the application aware HARQ process. For example, in the uplink, if per-CBG retransmissions are configured, the UE may determine which CBGs are to be retransmitted. For this purpose, a field is present in the downlink control information (DCI). This field is a CBG Transmit Indicator (CBGTI), which is a bitmap indicating whether a certain CBG needs to be present in the uplink transmission or not.

The signaling process including the ACK/NACK feedback in the application-aware HARQ process is the same as in classical HARQ. The single scenario that is not supported with the current signaling in the HARQ process is in the case of uplink retransmission, where the total weight meets or exceeds the threshold but the base station still requests retransmission for some or all non-decoded CBGs. In this scenario, the UE may send a request to the base station to stop requesting retransmissions. The decision may be based on the local parameters of the UE. Two options may be considered based on the local parameters state. In a first option, the UE may retransmit some or all of the requested CBGs using the classical retransmission mechanism. Given that the UE may determine not to retransmit all the requested CBGs in the DCI, the UE may include the corresponding CBGTI as part of uplink control information (UCI) to indicate which CBGs are retransmitted by the UE. Moreover, the UE can simultaneously ask the base station to stop requesting retransmission as part of the UCI that may be retransmitted either over the Physical Uplink Control Channel (PUCCH) or the Physical Uplink Shared Channel (PUSCH).

Similar to HARQ-ACK, a UCI carrying a STOP-RET request with 1 or 2 bits may be introduced may can be multiplexed by puncturing PUSCH. A UCI of Format 2, 3 or 4, e.g., supporting >2 bits, carrying the CBGTI can be used and transmitted over PUCCH given that Format 2 and Format 3 do not allow multiplexing. In case Format 4 is used, it can be multiplexed and transmitted over PUSCH.

In a second option, the UE may determine not to retransmit any of the requested CBGs by base station and may use the granted resources to send a STOP-RET request without retransmitting any CBGs or CBGTI. The UE may also send that information aver PUCCH.

No additional signaling is required for downlink.

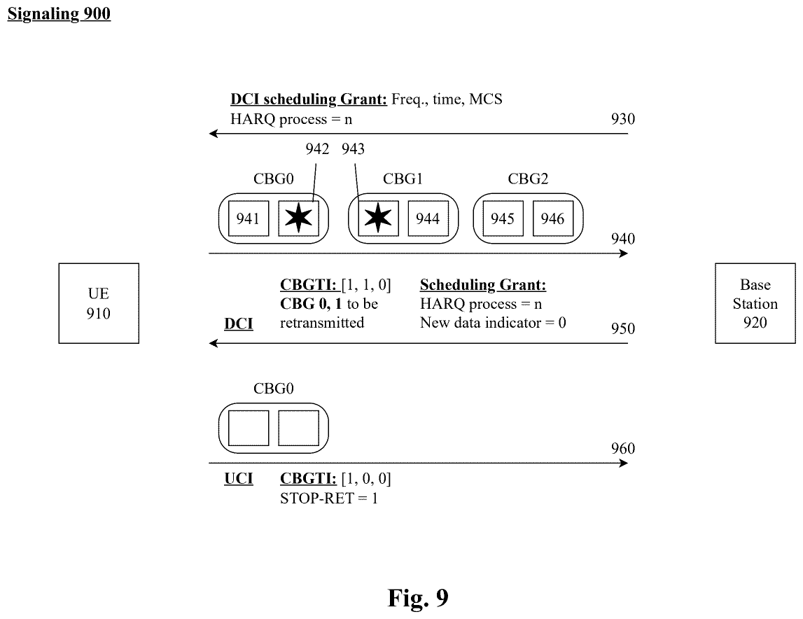

FIG. 9 shows a first example signaling 900 in the case of a UE-centric joint contextual and application aware HARQ process for uplink transmissions according to various example embodiments. The signaling 900 is performed between a UE 910 and a base station 920. As described above, in the UE-centric example embodiments, decisions with respect to HARQ retransmissions may be made based on the UE 910 local states and parameters.

In 930, the base station 920 sends a DCI scheduling grant to the UE 910. The scheduling grant may include various information including the time/frequency resources of the grant, the MCS to be used for the grant, the HARQ process number, etc.

In 940, the UE 910 transmits three CBGs (CBG0, CBG1 and CBG2 having corresponding code blocks 941-946) in the uplink. The base station 920 may receive the CBGs and perform decoding operations. In this example, the code block 942 of CBG0 and the code block 943 of the CBG1 may not have been successfully decoded by the base station 920.

In 950, the base station 920 may send further DCI to the UE 910. This DCI may include a CBGTI indicating that the base station 920 wants the UE 910 retransmit CBG0 and CBG1, e.g., the bitmap of the CBGTI indicates {1, 1, 0}. The DCI also includes a scheduling grant for the retransmission that identifies the HARQ process number and that the new data indicator is set to 0, meaning it is a grant for retransmission.

In this example, the UE 910 may determine to only retransmit the CBG0, e.g., based on the weight of the received CBGs and/or other local states or parameters of the UE 910 as described in detail above. Thus, in 960, the UE 910 retransmits CBG0 with UCI indicating that only CBG0 is being retransmitted, e.g., the bitmap of the CBGTI included in the UCI indicates {1, 0, 0}. The UCI also includes a STOP-RET set to 1 indicating that the UE 910 is requesting the base station 920 to stop requesting retransmission for the CBGs of this HARQ process.

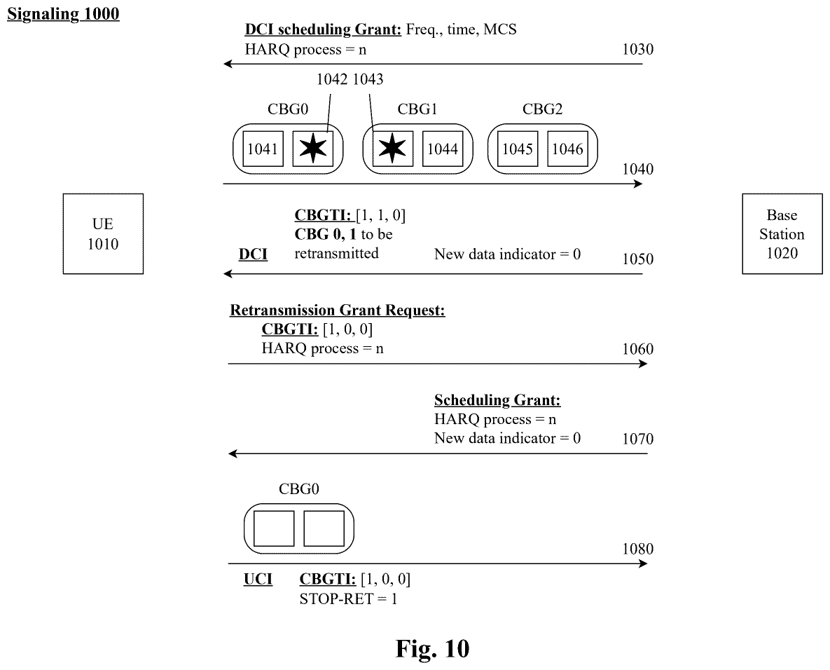

FIG. 10 shows a second example signaling 1000 in the case of a UE-centric joint contextual and application aware HARQ process for uplink transmissions according to various example embodiments. The signaling 1000 is performed between a UE 1010 and a base station 1020.

In 1030, the base station 1020 sends a DCI scheduling grant to the UE 1010. The scheduling grant may include various information including the time/frequency resources of the grant, the MCS to be used for the grant, the HARQ process number, etc.

In 1040, the UE 1010 transmits three CBGs (CBG0, CBG1 and CBG2 having corresponding code blocks 1041-1046) in the uplink. The base station 1020 may receive the CBGs and perform decoding operations. In this example, the code block 1042 of CBG0 and the code block 1043 of the CBG1 may not have been successfully decoded by the base station 1020.

In 1050, the base station 1020 may send further DCI to the UE 1010. This DCI may include a CBGTI indicating that the base station 1020 wants the UE 1010 retransmit CBG0 and CBG1, e.g., the bitmap of the CBGTI indicates {1, 1, 0}. The DCI may also include a new data indicator set to 0, meaning the DCI is for a retransmission.

In this example, the UE 1010 may determine to only retransmit the CBG0, e.g., based on the weight of the received CBGs and/or other local states or parameters of the UE 1010 as described in detail above. Thus, in 1060, the UE 1010 transmits a retransmission grant request indicating that only CBG0 is being retransmitted, e.g., the bitmap of the CBGTI indicates {1, 0, 0}, and identifying the HARQ process associated with the CBGTI.

In 1070, the base station 1020 sends a scheduling grant to the UE 1010 for retransmission of the CBG0. Again, the scheduling grant may include the time/frequency resources to be used for the uplink retransmission, an identification of the HARQ process number and the new data indicator set to 0.

In 1080, the UE may use retransmit the CBG0 using the uplink grant. The retransmission may also include UCI indicating that only CBG0 is being retransmitted, e.g., the bitmap of the CBGTI included in the UCI indicates {1, 0, 0}. The UCI also includes a STOP-RET set to 1 indicating that the UE 1010 is requesting the base station 1020 to stop requesting retransmission for the CBGs of this HARQ process.

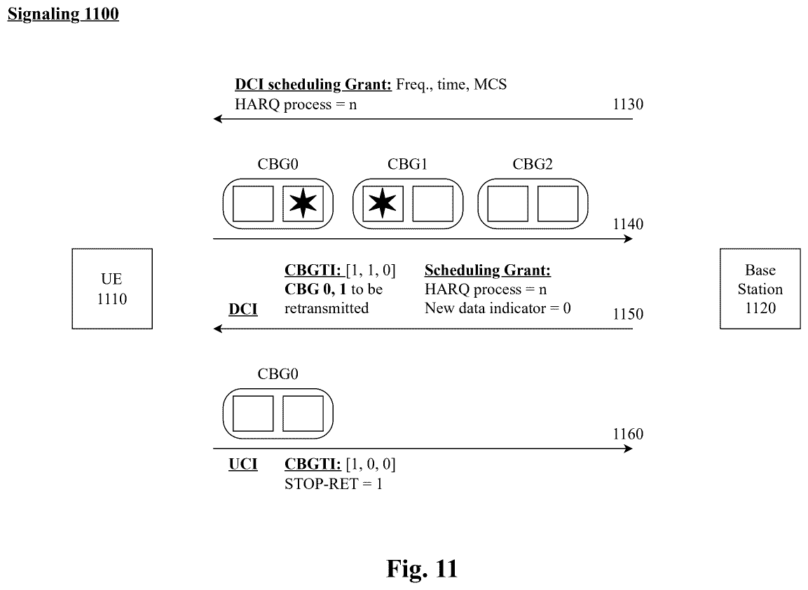

FIG. 11 shows an example signaling 1100 in the case of a joint contextual and application aware HARQ process for uplink transmissions according to various example embodiments. The signaling 1100 is performed between a UE 1110 and a base station 1120. As described above, in the joint contextual example embodiments, decisions with respect to HARQ retransmissions may be made based on both the UE 1110 and the base station 1120 local states and parameters.

In 1130, the base station 1120 sends a DCI scheduling grant to the UE 1110. The scheduling grant may include various information including the time/frequency resources of the grant, the MCS to be used for the grant, the HARQ process number, etc.

In 1140, the UE 1110 transmits three CBGs (CBG0, CBG1 and CBG2 having corresponding code blocks 1141-1146) in the uplink. The base station 1120 may receive the CBGs and perform decoding operations. In this example, the code block 1142 of CBG0 and the code block 1143 of the CBG1 may not have been successfully decoded by the base station 1120.

In this example, the base station 1120 may determine to only request the CBG0 be retransmitted. As described above, the base station 1120 may receive the minimum and/or maximum weight threshold(s) as part of the application related information. The base station 1120 may then evaluate whether to request retransmission of CBG0 and CBG1.

For example, as described above, the base station 1120 may evaluate the weight w_{current} of the successfully decoded CBS and compares it to the two weight thresholds specified by the UE and/or application, wₘᵢₙ and wₘₐₓ. Thus, if w_{current}<wₘᵢₙ, the base station 1120 may schedule an uplink grant for retransmission of all non-decoded CBGs (NACK), e.g., CBG 0 and CBG 1. If wₘᵢₙ<w_{current}<wₘₐₓ, the base station 1120 may determine to schedule an uplink grant for a single CBG and may request retransmission (NACK) for CBG 0 only. An ACK may transmitted for other CBGs (e.g., CBG1). If w_{current}>wₘₐₓ, the base station 1120 may not schedule any uplink grant for retransmission and an ACK is transmitted for all CBGs. In the example of FIG. 11, the scenario considered is the wₘᵢₙ<w_{current}<wₘₐₓ scenario.

Thus, in 1150, the base station 1120 may send further DCI to the UE 910. This DCI may include a CBGTI indicating that the base station 920 wants the UE 910 retransmit CBG0, e.g., the bitmap of the CBGTI indicates {1, 0, 0}. The DCI also includes a scheduling grant for the retransmission that identifies the HARQ process number and that the new data indicator is set to 0, meaning it is a grant for retransmission.

Thus, in 1160, the UE 1110 retransmits CBG0 with UCI indicating that only CBG0 is being retransmitted, e.g., the bitmap of the CBGTI included in the UCI indicates {1, 0, 0}. The UCI also includes a STOP-RET set to 1 indicating that the UE 1110 is requesting the base station 1120 to stop requesting retransmission for the CBGs of this HARQ process.

As stated above, another aspect of the example embodiments is application aware scheduling. In application aware scheduling, the data may be structured into multiple data blocks as described above (e.g., due to different weights). Each sub-flow (SF)/data block may be linked to a specific configuration. In some examples, different SF/data blocks may be linked to the same configuration. A base station may allocate different priorities to scheduling requests (SRs) based on the SF/data blocks rather than the logical channels.

In some example embodiments, a logical channel may be linked to the configuration of the highest weighted SF/data block that has data to be transmitted. In these example embodiments, the base station may allocate different priorities to SRs based on the logical channel that triggered the SR.

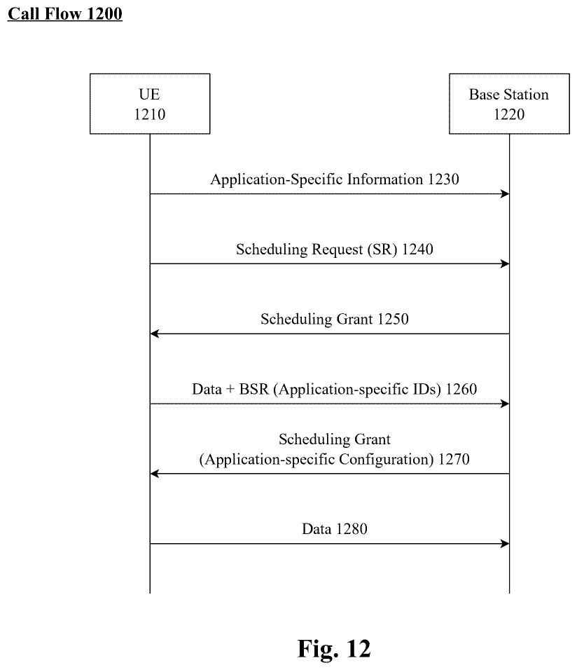

FIG. 12 shows a call flow 1200 for application aware scheduling according to various example embodiments. The call flow is performed between a UE 1210 and a base station 1220. As described in greater detail below, the UE 1210 may inform the base station 1220 about the application-related information of the buffered data (e.g., through an updated version of a buffer status report (BSR)).

In 1230, the UE 1210 may provide the base station 1220 with application-specific information to inform the base station 1220 about information provided by an application (e.g., priority, accepted error rate, etc.) for each sub-flow/data block.

In 1240, when the UE 1210 has data to transmit, the UE 1210 may send an SR to the base station 1220 and, in 1250, receive a scheduling grant from the base station 1220.

In 1260, the UE 1210 may send a BSR to inform the base station 1220 about the buffered data per sub-flow/data block and/or per logical channel group (e.g., application application-related information). The base station 1220 may use the application-related information to determine a grant calculation to achieve effective resource utilization and user experience. Examples of using the application-related information to determine a grant calculation are described in further detail below.

In 1270, the base station 1220 may send a scheduling grant with an application specific configuration to the UE 1210. In 1280, the UE 1210 may use the grant to transmit the data in the buffer in the uplink.

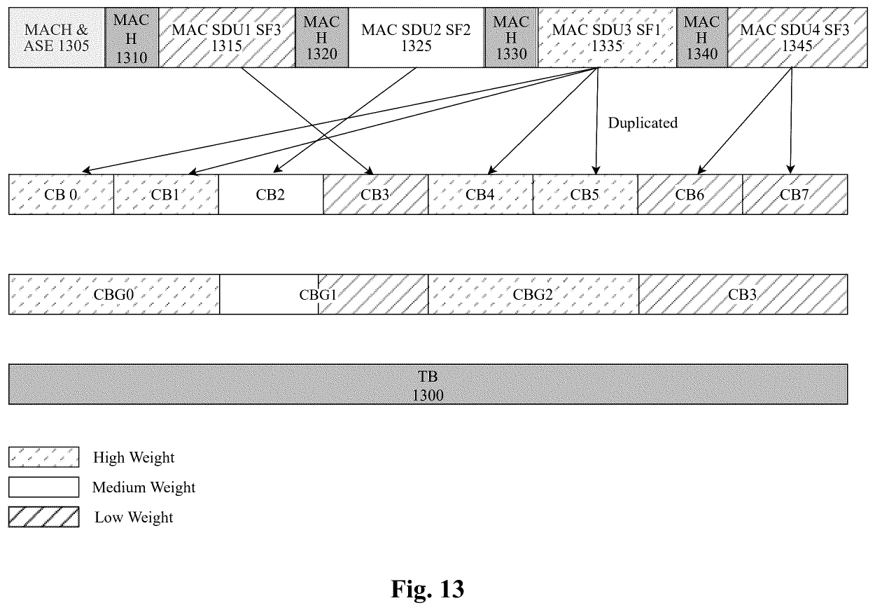

FIG. 13 shows a first example of an application aware grant calculation according to various example embodiments. In this example, based on the various information (e.g., available resources, application-aware configuration, channel conditions, size of buffered data, etc.), the base station may allocate resources to allow the UE to duplicate the high weighted data to increase the probability of successful transmission and reduce the probability of transmission failure.

The base station may configure the UE with application-specific configurations to inform the UE that the allocated resources allow the UE to duplicate the high weighted data. Based on the received grants, the application-specific configuration, the buffered data, etc. the UE may duplicate the high weighted data as illustrated in the FIG. 13.

In FIG. 13, a transport block (TB) 1300 is generated from a global MAC header 1305 and MAC sub-headers 1310-1325 that include application specific information. As shown in FIG. 13, each MAC sub-header is associated with a MAC service data unit (SDU), e.g., MAC sub-header 1310 is associated with MAC SDU 1315, MAC sub-header 1320 is associated with MAC SDU 1325, MAC sub-header 1330 is associated with MAC SDU 1335 and MAC sub-header 1340 is associated with MAC SDU 1345. Each of the MAC SDUs has a weight as shown in the key.

Code blocks (CBs) (e.g., CB0-CB7) may be generated from the MAC SDUs. As shown in FIG. 13, the highest weight MAC SDU, e.g., MAC SDU 1335, may be duplicated multiple times within the CBs, e.g., CB0, CB1, CB4 and CB5. The medium weight SDU, e.g., MAC SDU 1325, may be inserted after the first instance of the high weight MAC SDUs and the low weight MAC SDUs may be inserted after the medium weight SDUs. The CBs are then used to generate code block groups, e.g., CBG0-CBG3, and then transmitted as TB 1300.

Thus, if one copy of the MAC SDU 1335 (e.g., CB0 and CB1 or CB4 and CB5) is corrupted, there is no need for retransmission if the other copy is correctly received. The duplication may be performed at different levels, e.g., MAC SDU, Data Blocks, CB, etc.

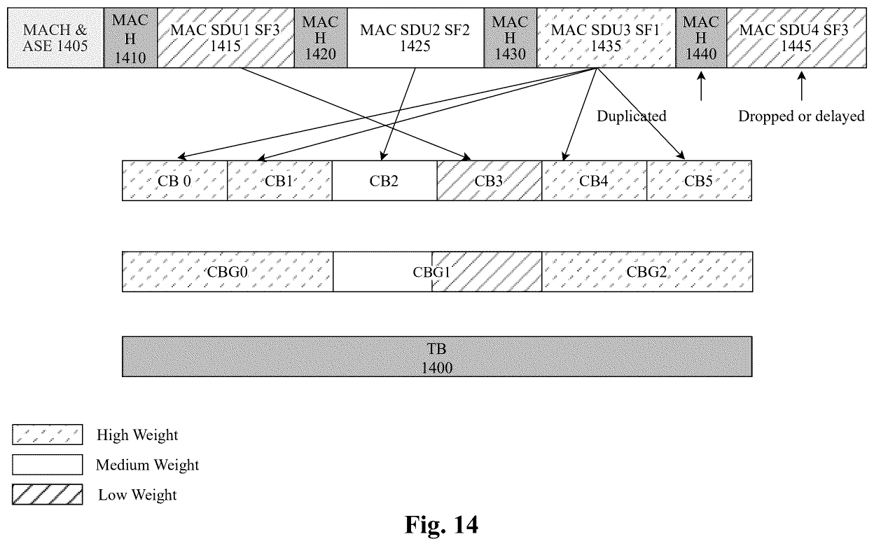

FIG. 14 shows a second example of an application aware grant calculation according to various example embodiments. In this example, based on the various information (e.g., available resources, application-aware configuration, channel conditions, size of buffered data, etc.) the base station may ignore the low weighted data for the resource allocation. The base station may inform the UE that low(er) weighted data is going to be discarded/ignored. The base station may implement this example when the base station determines that ignoring the low weighted data may impact the user experience but this impact is within an acceptable range. The base station may determine the impact is within the acceptable range based on the application-specific information provided by the UE.

The base station may implement this solution when, for example, the network is in high load and/or congested scenarios, when there is a bad coverage scenario, and when limited resources are available, the base station may use this solution to free resources to enable the duplication of high weighted data.

In FIG. 14, a transport block (TB) 1400 is generated from a global MAC header 1405 and MAC sub-headers 1410-1425 that include application specific information. As shown in FIG. 14, each MAC sub-header is associated with a MAC service data unit (SDU), e.g., MAC sub-header 1410 is associated with MAC SDU 1415, MAC sub-header 1420 is associated with MAC SDU 1425, MAC sub-header 1430 is associated with MAC SDU 1435 and MAC sub-header 1440 is associated with MAC SDU 1445. Each of the MAC SDUs has a weight as shown in the key.

Similar to FIG. 13, code blocks (CBs) (e.g., CB0-CB5) may be generated from the MAC SDUs. As shown in FIG. 14, the highest weight MAC SDU, e.g., MAC SDU 1435, may be duplicated multiple times within the CBs, e.g., CB0, CB1, CB4 and CB5. The medium weight SDU, e.g., MAC SDU 1425, may be inserted after the first instance of the high weight MAC SDUs and the low weight MAC SDUs may be inserted after the medium weight SDUs. However, in this example, there are not enough CBs to accommodate all the low weight MAC SDUs. Thus, the MAC SDU 1445 may be dropped or delayed as described above. The CBs are then used to generate code block groups, e.g., CBG0-CBG2, and then transmitted as TB 1400.

Typically, a UE serves the logical channel(s) in the following sequence: 1. All relevant logical channels in decreasing priority order up to their prioritized bit rate (PBR); 2. All relevant logical channels in decreasing priority order for the remaining resources assigned by the grant.

However, using the application-specific information of the example embodiments, the UE may serve the logical channel(s) using one or more of the following options to achieve an improved user experience. In a first option, a PBR may be assigned for each sub-flow. The logical channel PBR is the summation of the PBRs of all sub-flows in this logical channel. During UL transmission, the UE serves the logical channel(s) in the following sequence: 1. All relevant logical channels in decreasing priority order up to their prioritized bit rate (PBR), where within each logical channel the UE serves the sub-flows in decreasing priority order up to their a prioritized bit rate (PBR); and 2. All relevant logical channels in decreasing priority order for the remaining resources assigned by the grant, where within each logical channel, the UE serves the sub-flows in decreasing priority order.

In a second option, a PBR may be assigned for each sub-flow. During UL transmission, the UE serves the logical channel(s) in the following sequence: 1. All relevant sub-flows (from any logical channel) in decreasing priority order up to the prioritized bit rate (PBR); and 2. All relevant sub-flows (from any logical channel) in decreasing priority order for the remaining resources assigned by the grant.

In a third option, a generic function may be used to leverage the information in the MAC SDU headers and the application-specific header such as, weights, interdependence between sub-flows, sub-flow requirements in terms of delay budget and potentially other KPIs, as well as environment related information such as BSR, available resources, and channel conditions. A function, e.g., heuristic, may then be used to define whether any of the MAC SDUs are to be duplicated, discarded or allocated in a specific way in the TB to achieve the sub-flow/data unit requirements. The input to the function may be all the PBR, priority/relevance of the sub-flows, interdependence, BSR, available resources. The output of the function may be a mapping of MAC SDUs and TB allocation based on available resources.

In the downlink, based on the available resources, application-specific configuration, channel conditions, size of buffered data, etc., the base station may ignore the low weighted data and send only medium and high weighted data. This solution may be used when the base station determines that ignoring the low weighted data may impact the user experience but this impact is within an acceptable range that the base station may know from the application-specific information in the header.

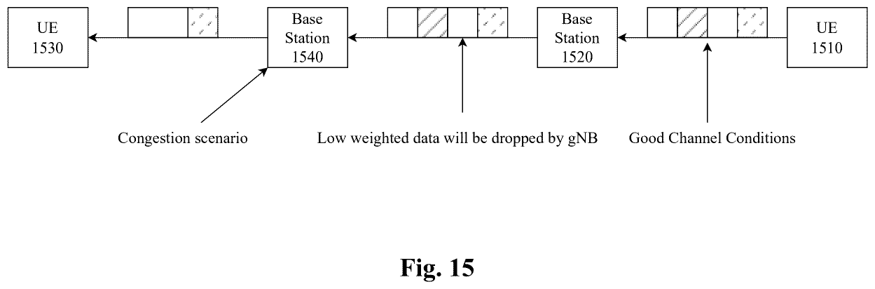

FIG. 15 shows an example of application aware scheduling in the downlink according to various example embodiments. In FIG. 15, the following scenario may exist. The UE 1510 may be connected to the base station 1520 with good channel conditions. The UE 1530 is connected to the base station 1540 while the base station 1540 is congested and has limited resources. The UE 1510 has data to send to the UE 1530. Since the UE 1510 is in good conditions, the UE 1510 sends data from all sub-flows/data blocks including the low weighted data. When the base station 1540 receives the data from the user plane function (UPF) and due to the congestion situation and limited resources, the base station 1540 may determine to drop the low weighted data if the impact on the end user experience is within an acceptable range as known from header. In another option, the UPF may perform the ignoring/discarding of low weighted data.

In some example embodiments, in the downlink, based on the available resources, application-specific configuration, channel conditions, size of buffered data, etc., the base station may duplicate the high weighted data to increase the probability of successful transmission and reduce the probability of transmission failure.

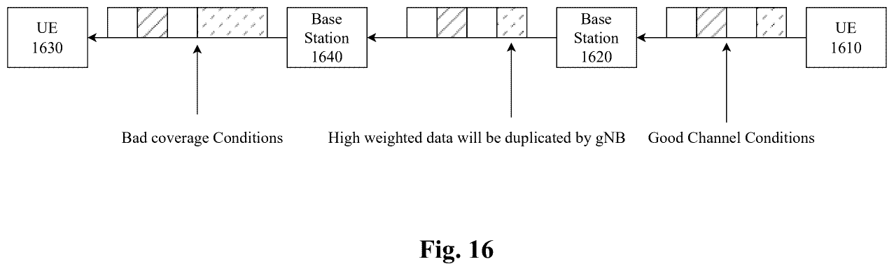

FIG. 16 shows a second example of application aware scheduling in the downlink according to various example embodiments. In FIG. 16, the following scenario may exist. The UE 1610 may be connected to the base station 1620 with good channel conditions. The UE 1630 is connected to the base station 1640 with bad coverage conditions. The UE 1610 has data to send to the UE 1630. Since the UE 1610 is in good conditions, the UE 1610 sends data from all sub-flows/data blocks including the low weighted data. When the base station 1640 receives the data from the UPF and the base station 1640 determined the UE 1630 is located in a bad coverage condition, the base station 1640 may determine to duplicate the high weighted data. In another option, the duplication of high weighted data may be performed by the UPF. In addition, the duplication may be performed in different levels, e.g., MAC SDU, Data Blocks, CB, etc.

In the first aspect of the example embodiments, an improved HARQ process using application aware information was described. This HARQ process may be modified to account for duplicate data as described above.

The duplication at the MAC layer may occur at different granularities. For example, the duplication may occur at the CBG level where a CBG can be duplicated depending on the weight of the MAC SDUs it contains. For instance, a CBG containing MAC SDUs with highest weight can be duplicated while CBGs containing MAC SDUs with lowest weight are not duplicated. The number of duplicates per CBG can be different from one CBG to another depending on the weight of the MAC SDUs they contain.

The duplication may also occur at the MAC SDU, PDU, data block or data representation level. The MAC SDUs are duplicated depending on the weight of the PDUs they contain. Thus, all the CBG belonging to the same MAC SDU, PDU, data block or data representation, are duplicated. The duplication of the MAC SDUs, PDUs, data blocks or data representations all follow the same process, e.g., duplication based on data relevance, and can be treated in the same way in the HARQ process.

In the case of MAC SDU, PDU, data block or data representation based duplication, all the operations for the evaluation process of successful data unit reception are the same as the case when there are no duplicates, e.g., the operations described above with reference to FIG. 7, with the exception of determining the total weight, e.g., the operation 730 described above.

When determining the total weight when duplicates are present, the receiver may identify the data blocks that are correctly received for every data representation. Given that each data block is associated with a weight that is included in the TB header or TB sub-headers as well as the interdependency relationship between data blocks, the receiver may determine the total weight of the correctly received data blocks for a given data representation. In the case of the presence of duplicates, the receiver may identify the redundant data blocks (MAC SDUs, or CBGs) and only count them once as part of the total weight. The remaining operations, e.g., comparing the total weight to the threshold may be performed in a similar manner as was described above.

In the case of CBG-based duplication, information on whether a CBG is a duplicate may not be available since there are no headers to pass such information to the receiver. To handle this issue, two options may be used to inform the receiver about the number of duplicates per CBG. In a first option, a bit map based solution may be used. For example, the original CBG-corresponding bit would receive a value 1 and the duplicates would receive a value 0. The receiver can check whether at least one copy of a given CBG was correctly received and skip retransmission requests of the copies if any.

In a second option, an agreement based duplication may be used. For example, signaling between the transmitter and the receiver may be used to agree on the number of duplicates that are transmitted per weight/priority. The receiver may identify the duplicated CBGs based on the weight of the CBGs/MAC SDUs that is contained as part of the header.

In addition to the evaluation process, some changes to the ACK/NACK feedback report may also be used. The receiver may identify all the duplicates of a given data block, which is specified as part of the headers, based on the corresponding decoded CBGs. If at least one of the duplicates is received and successfully decoded, e.g., the actual weight is higher than the required threshold to consider a data block as successfully received, an ACK is transmitted for all the duplicates, e. g., their corresponding code blocks. If a code block group (CBG) contains code blocks (CBs) from different data blocks, then the ACK/NACK feedback value is defined based on whether any of the CBs within the CBG requires retransmission. For example, if a single CB within a CBG belongs to a data block that requires retransmission, then a NACK is reported for the whole CBG so that it is retransmitted.

If none of the duplicates is received and successfully decoded, the number of duplicates that need to be assigned a NACK feedback report may be configured dynamically. For example, in case the data block is of high priority and has strict latency requirements, a NACK may be assigned to the data block and all its duplicates, e.g., the corresponding CBGs. Otherwise, a NACK feedback may be reported for only one of the duplicates, e.g., the corresponding CBGs.

### EXAMPLES

In a first example, a method, comprising generating, for transmission to a network, application specific information related to one of a sub-flow or data blocks of a data flow for an application, generating, for transmission to the network, a buffer status report comprising information related to buffered data, wherein the information is provided per sub-flow or data block, per logical channel group for the application, processing, based on signaling from the network, a scheduling grant comprising an application specific configuration based on the information related to buffered data.

In a second example, the method of the first example, wherein the application specific information comprises one of a priority or an accepted error rate for the one of the sub-flow or data blocks.

In a third example, the method of the first example, wherein the application specific configuration comprises an indication that data having a weight above a threshold is to be duplicated.

In a fourth example, the method of the third example, further comprising generating a transport block using the buffered data, wherein the transport block comprises duplicate data for at least some of the data having the weight above the threshold.

In a fifth example, the method of the first example, wherein the application specific configuration comprises an indication that data having a weight below a threshold is to be discarded.

In a sixth example, the method of the fifth example, further comprising discarding the data having the weight below the threshold.

In a seventh example, the method of the first example, wherein the sub-flows or data blocks are associated with a logical channel, wherein the data is transmitted in decreasing priority order up to a prioritized bit rate (PBR) of the corresponding logical channel and then data is transmitted in decreasing priority order for any remaining resources assigned by the scheduling grant.

In an eighth example, the method of the seventh example, wherein, within each logical channel, data is transmitted in decreasing priority order corresponding to the sub-flows.

In a ninth example, a method, comprising processing, based on signaling from a user equipment (UE), application specific information related to one of a sub-flow or data blocks of a data flow for an application being executed by the UE, processing, based on signaling from the UE, a buffer status report comprising information related to buffered data, wherein the information is provided per sub-flow or data block, per logical channel group for the application, generating, for transmission to the UE, a scheduling grant comprising an application specific configuration based on the information related to buffered data.

In a tenth example, the method of the ninth example, wherein the application specific information comprises one of a priority or an accepted error rate for the one of the sub-flow or data blocks.

In an eleventh example, the method of the ninth example, wherein the application specific configuration comprises an indication that data having a weight above a threshold is to be duplicated.

In a twelfth example, the method of the ninth example, wherein the application specific configuration comprises an indication that data having a weight below a threshold is to be discarded.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e. g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry coupled to memory, the processing circuitry configured to:
process, based on signals received from a base station, a data unit comprising one or more representations, each of the representations comprising one or more data blocks, wherein each data block comprises a weight and wherein each of the data blocks is assigned to one of a plurality of code block groups (CBGs) based on the weight of the corresponding data block;
determine a total weight of the data blocks that are successfully decoded; and
compare the total weight to a total weight threshold for the data unit.

2. The apparatus of claim 1, wherein the processing circuitry is further configured to:
when the total weight satisfies the total weight threshold, generate, for transmission to the base station, an acknowledgment (ACK) for the data unit.

3. The apparatus of claim 1, wherein the processing circuitry is further configured to:
when the total weight does not satisfy the total weight threshold, determine any CBGs that have not been successfully decoded; and
generate, for transmission to the base station, a negative acknowledgment (NACK) for the CBGs that have not been successfully decoded.

4. The apparatus of claim 1, wherein the processing circuitry is further configured to:
when the total weight satisfies the total weight threshold, determine any CBGs that have not been successfully decoded; and
generate, for transmission to the base station, a negative acknowledgment (NACK) for the CBGs that have not been successfully decoded.

5. The apparatus of claim 1, wherein the CBGs are received in Medium Access Control (MAC) Service Data Units (SDUs) and wherein the MAC SDUs having a highest weight are decoded first.

6. An apparatus comprising processing circuitry configured to:
generate, for transmission to a base station, a data unit comprising one or more representations, each of the representations comprising one or more data blocks, wherein each data block comprises a weight and wherein each of the data blocks is assigned to one of a plurality of code block groups (CBGs) based on the weight of the corresponding data block.

7. The apparatus of claim 6, wherein the processing circuitry is further configured to:
determine an amount of time since transmission of the data unit is greater than a predetermined time threshold;
determine, based on the amount of time since transmission of the data unit being greater than the predetermined time threshold, the data unit was successfully delivered to the base station.

8. The apparatus of claim 6, wherein the processing circuitry is further configured to:
process, based on signals received from the base station, a negative acknowledgment (NACK) for the data unit, wherein the NACK identifies CBGs that have not been successfully decoded by the base station; and
determine whether CBGs that have been successfully decoded by the base station have a total weight that satisfies a total weight threshold for the data unit.

9. The apparatus of claim 8, wherein the processing circuitry is further configured to:
when the total weight does not satisfy the total weight threshold, generate, for retransmission to the base station, the CBGs that have not been successfully decoded by the base station.

10. The apparatus of claim 9, wherein the processing circuitry is further configured to:
process, based on signals received from the base station, downlink control information (DCI) comprising a CBG Transmit Indicator (CBGTI) that includes a bitmap indicating an identity of CBGs to be present in the retransmission.

11. The apparatus of claim 8, wherein the processing circuitry is further configured to:
when the total weight satisfies the total weight threshold, generate, for retransmission to the base station, a subset of the CBGs that have not been successfully decoded by the base station.

12. The apparatus of claim 11, wherein the processing circuitry is further configured to:
process, based on signals received from the base station, downlink control information (DCI) comprising a CBG Transmit Indicator (CBGTI) that includes a bitmap indicating an identity of CBGs to be present in an uplink retransmission; and
generate, for transmission to the base station, uplink control information (UCI) comprising a CBGTI that includes a bitmap indicating an identity of the subset of CBGs.

13. The apparatus of claim 8, wherein the processing circuitry is further configured to:
when the total weight satisfies the total weight threshold, generate, for transmission to the base station, a request for the base station to discontinue requests for retransmissions of the CBGs that have not been successfully decoded.

14. The apparatus of claim 6, wherein the plurality of CBGs comprise one or more duplicate CBGs.

15. The apparatus of claim 14, wherein the processing circuitry generates duplicate CBGs based on one or more of available resources, an application-specific configuration, channel conditions, or a size of buffered data.

16. An apparatus comprising processing circuitry configured to:
process, based on signals received from a user equipment (UE), a data unit comprising one or more representations, each of the representations comprising one or more data blocks, wherein each data block comprises a weight and wherein each of the data blocks is assigned to one of a plurality of code block groups (CBGs) based on the weight of the corresponding data block;
determine a total weight of the data blocks that are successfully decoded; and
compare the total weight to a total weight threshold for the data unit.

17. The apparatus of claim 16, wherein the processing circuitry is further configured to:
when the total weight satisfies the total weight threshold, discontinue processing the data unit.

18. The apparatus of claim 16, wherein the processing circuitry is further configured to:
when the total weight does not satisfy the total weight threshold, determine any CBGs that have not been successfully decoded; and
generate, for transmission to the base station, a negative acknowledgment (NACK) for the CBGs that have not been successfully decoded.

19. The apparatus of claim 16, wherein the processing circuitry is further configured to:
when the total weight satisfies the total weight threshold, determine any CBGs that have not been successfully decoded; and
generate, for transmission to the base station, a negative acknowledgment (NACK) for the CBGs that have not been successfully decoded.

20. The apparatus of claim 16, wherein the CBGs are received in Medium Access Control (MAC) Service Data Units (SDUs) and wherein the MAC SDUs having a highest weight are decoded first.
